(19) United States
(12) Patent Application Publication
(10) Pub. No.: US 2025/0005526 A1
(43) Pub. Date: Jan. 2, 2025

(54) ARTIFICIAL INTELLIGENCE ENHANCED COLLABORATION IN VIRTUAL WORLDS

(71) Applicant: INTERNATIONAL BUSINESS MACHINES CORPORATION, Armonk, NY (US)

(72) Inventor: Sarbajit K. Rakshit, Kolkata (IN)

(21) Appl. No.: 18/216,137

(22) Filed: Jun. 29, 2023

(51) Int. Cl. G06Q 10/10

(52) U.S. Cl. CPC G06Q 10/103

(57) ABSTRACT

A method, system, and computer program product are configured to: determine that participants in a metaverse collaborative event are not asking sufficient questions to a presenter of the metaverse collaborative event, wherein the metaverse collaborative event takes place in a three-dimensional space in a virtual world and the participants and presenter are visible to each other in the three-dimensional space, and wherein a sufficiency of questions is based on a predefined criteria; and in response to the determining, cause a dummy avatar in the metaverse collaborative event to ask a question to the presenter during the metaverse collaborative event.

### BACKGROUND

Aspects of the present invention relate generally to virtual worlds and, more particularly, to artificial intelligence enhanced collaboration in virtual worlds.

A virtual world (also called a virtual universe or VU) is a computer-generated three-dimensional space in which users can interact with a computer-generated objects and other users. Users may access such virtual worlds by utilizing virtual reality (VR) and augmented reality (AR) devices. A user may be represented in a virtual world by an avatar, which is a digital object rendered in the virtual world and visible to other users in the virtual world. A metaverse is an example of a network of virtual worlds that are focused on social and economic connections.

### SUMMARY

In an aspect of the invention, there is a computer-implemented method that includes: determining, by a processor set, that participants in a metaverse collaborative event are not asking sufficient questions to a presenter of the metaverse collaborative event. The metaverse collaborative event takes place in a three-dimensional space in a virtual world and the participants and presenter are visible to each other in the three-dimensional space. A sufficiency of questions is based on a predefined criteria. The method further includes, in response to the determining, causing, by the processor set, a dummy avatar in the metaverse collaborative event to ask a question to the presenter during the metaverse collaborative event. In this manner, implementations determine when conversation is insufficient in the metaverse collaborative event and stimulate the conversion using a dummy avatar, which enhances (e.g., improves) the quality of the metaverse collaborative event.

The method may further comprise causing the dummy avatar to display one or more positive influencing factors to the participants and the presenter. This provides positive feedback to the presenter, which advantageously helps the presenter perform their best during the event.

The method may further comprise masking negative influencing factors of one or more of the participants. This shields the presenter from negative reactions that could detract from the presenter's performance during the event.

The method may further comprise inviting one or more of the participants to the metaverse collaborative event based on determining that the one or more of the participants are interested in the metaverse collaborative event. This advantageously populates the event with participants who are likely to improve the quality of the event by asking questions and/or providing positive feedback to the presenter.

The method may further comprise dynamically rearranging the participants to different locations in the three-dimensional space. This advantageously provides a better view of the participants for the presenter, which can improve the presenter's performance.

In the method, the determining that the participants in the metaverse collaborative event are not asking sufficient questions may comprise comparing questions asked during the metaverse collaborative event to questions determined from a knowledge corpus. This advantageously causes appropriate questions to be asked for this type of event. The method may further comprise creating the knowledge corpus based on analyzing plural different historic metaverse collaborative events. This advantageously determines the appropriate questions to be asked for this type of event.

In the method, the determining that the participants in the metaverse collaborative event are not asking sufficient questions may comprise determining that one of the participants does not understand a topic presented by the presenter during the metaverse collaborative event. This advantageously assists participants to understand the content of the event.

In other aspects of the invention, there are a computer program product and a system that are configured to perform the above-described method.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary method in accordance with aspects of the present invention.

FIG. 4 shows a flowchart of an exemplary method in accordance with aspects of the present invention.

FIG. 5 shows a flowchart of an exemplary method in accordance with aspects of the present invention.

FIGS. 6A, 6B, and 6C illustrate example use cases in accordance with aspects of the present invention.

### DETAILED DESCRIPTION

Aspects of the present invention relate generally to virtual worlds and, more particularly, to artificial intelligence enhanced collaboration in virtual worlds. According to aspects of the invention, an AI-enabled system analyzes the context of collaboration in a metaverse collaborative event (e.g., such as a virtual world meeting, presentation, performance, etc.), how the event is progressing, and the participants of the events. Based on this analysis, the system dynamically places appropriate numbers and types of dummy avatars in the virtual world environment of the metaverse collaborative event, the dummy avatars being configured to ask appropriate questions during the event when the participants in the event are not asking sufficient questions. In embodiments, the dummy avatars are used to enhance the emotional effectiveness among the participants of the metaverse collaborative event when the participants are not able to make required level of emotional effectiveness in the event. In this manner, implementations of the invention enhance the quality of metaverse collaborative events.

While attending an event in a metaverse collaborative environment, the participants of the event are able to visualize who is present in the metaverse collaborative environment. It is common practice for a presenter at such an event to look for positive feedback from other participants of the event, such as friends, family members, colleagues, mentors, teachers, etc. At the same time, the actions of some participants of the event may have a negative impact on the presenter during the event. In a metaverse collaboration, if the presenter does not have an audience of participants that provides positive feedback, then the presenter often will not be able to perform to the top of their ability during the event.

Implementations of the invention provide a technical solution to the above-noted problems by inviting users to be participants in a metaverse collaborative event, where the invited users are determined using artificial intelligence to be interested in the event. Users that are interested in the event are more likely to ask questions and provide positive feedback to the presenter of the event. In this manner, implementations of the invention improve the experience of the presenter during the event by providing an audience of participants that is likely to provide positive feedback to the presenter during the event.

Implementations of the invention provide a technical solution to the above-noted problems by causing a dummy avatar to ask topical questions in a metaverse collaborative event when it is determined that actual user participants (e.g., non-dummy avatars) are not asking sufficient questions during the event. The act of asking topical questions, when none are being asked, can provide positive feedback to the presenter. The act of asking topical questions can also assist participants that are having trouble understating a topic but have decided not to ask a question for whatever reason. In this manner, implementations of the invention improve the experience of all the participants of the event (e.g., the presenter and the audience members) by controlling dummy avatars to stimulate topical conversation during the event.

Implementations of the invention provide a technical solution to the above-noted problems by dynamically rearranging the participants of the event to different locations in the virtual world space where the event is taking place. Spreading out the avatars of participants provides better visual feedback for a presenter compared to the situation where all of the participants are grouped together in a single location such as a back corner of the meeting space of the event. Spreading out the avatars of participants also increases the likelihood that questions will be asked from different locations within the meeting space of the event, which can make other participants feel more at ease in asking their own questions during the event.

Implementations of the invention thus provide improvements in the field of virtual worlds. The improvements are technical in nature because, in one aspect, an improvement comprises controlling dummy avatars in a virtual world. The improvements are technical in nature because, in another aspect, an improvement comprises dynamically rearranging avatars of participants in a virtual world. The improvements are technical in nature because, in another aspect, an improvement comprises automatically inviting users who are determined to be interested in a virtual world event, where the determination is made using artificial intelligence.

In accordance with aspects of the invention, a method, system, and computer program product are configured to determine: a context of a metaverse event (e.g., technical presentation, musical concert, etc.); a profile of a presenter in the event (e.g., a teacher, panel member, performer, etc.); and a timing of the event. In accordance with aspects of the invention, the method, system, and computer program product are configured to use artificial intelligence to identify how the performance of the presenter during the event can be enhanced (e.g., maximized) so that high quality metaverse collaboration content can be created. In embodiments, to achieve this enhancement, the method, system, and computer program product are configured to perform one or more of: proactively invite appropriate audience members (e.g., participants) who are determined to be appreciative of the presenter and/or helpful to cause the presenter to perform in a better way than would otherwise occur; dynamically rearrange the audience members in the metaverse surrounding so that the presenter is motivated to perform better; make the metaverse collaborative environment vibrant and interactive; mask negative influencing factors of participants; place an appropriate number of dummy avatars in the metaverse collaborative environment to assist when actual audience members are not interacting with the presenter; and create a context appropriate metaverse collaborative environment so that the level of motivation and encouragement among the audience members is enhanced.

In accordance with aspects of the invention, the method, system, and computer program product are further configured to gather information about historic (e.g., prior) metaverse collaboration events, the information including one or more of: feedback from a presenter on their performance during the event; information about the metaverse collaborative environment (e.g., number of participants, amount and type of positive interaction, amount and type of negative interaction, etc.); metaverse collaboration content; feedback from the audience members on the recorded metaverse collaboration content. In accordance with aspects of the invention, the method, system, and computer program product are configured to perform a historic learning function that includes analyzing the information using artificial intelligence to determine patterns, trends, associations, etc., in the information. In embodiments, the method, system, and computer program product are configured to use the historic learning to identify influencing factors that can enhance the quality of the metaverse collaboration content and how the presenter can perform their best in various situations. In embodiments, the method, system, and computer program product are configured to use the historic learning to create a knowledge corpus of learned data, and then use the knowledge corpus to determine one or more of the above-noted actions to perform in a current metaverse collaboration event in order to enhance the quality of the current metaverse collaboration event.

Implementations of the invention are necessarily rooted in computer technology. Virtual worlds are inherently computer-based. Controlling the actions of dummy avatars in a virtual world and rearranging the locations of user avatars in a virtual world comprise computer-based functions that affect and control the appearance of the virtual world (e.g., rendering, etc.), and these functions are necessarily carried out by a computer-based system. Moreover, artificial intelligence, which may be used in various aspects as described herein, is necessarily performed by a computer.

It should be understood that, to the extent implementations of the invention collect, store, or employ personal information provided by, or obtained from, individuals (for example, user profiles in a virtual world) such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as metaverse enhancement code at block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

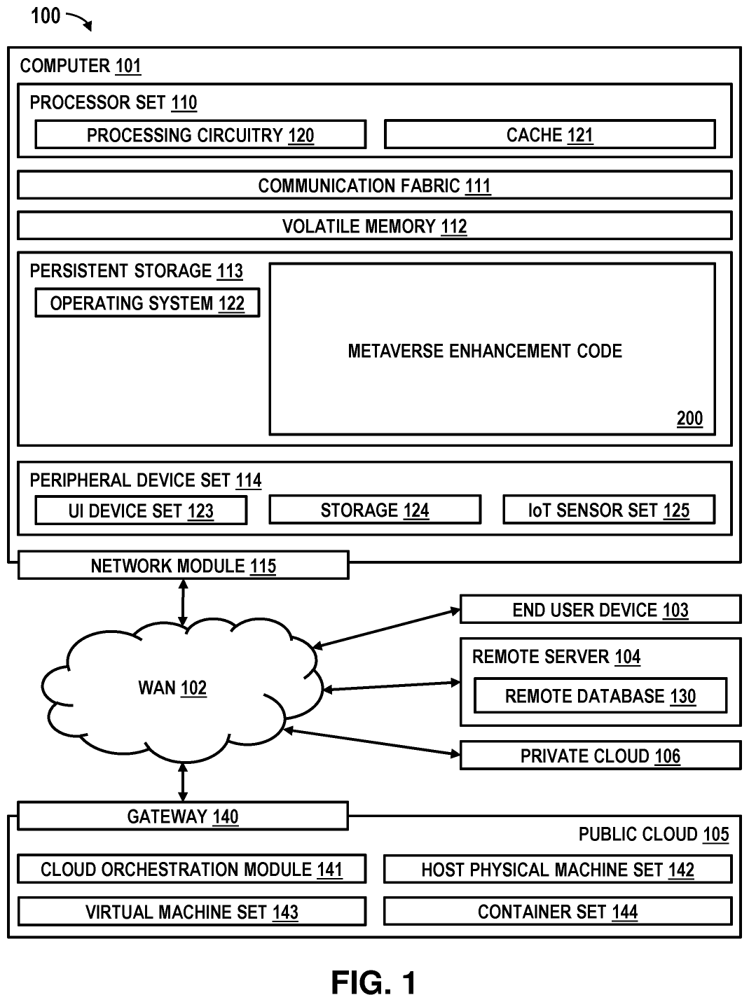

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

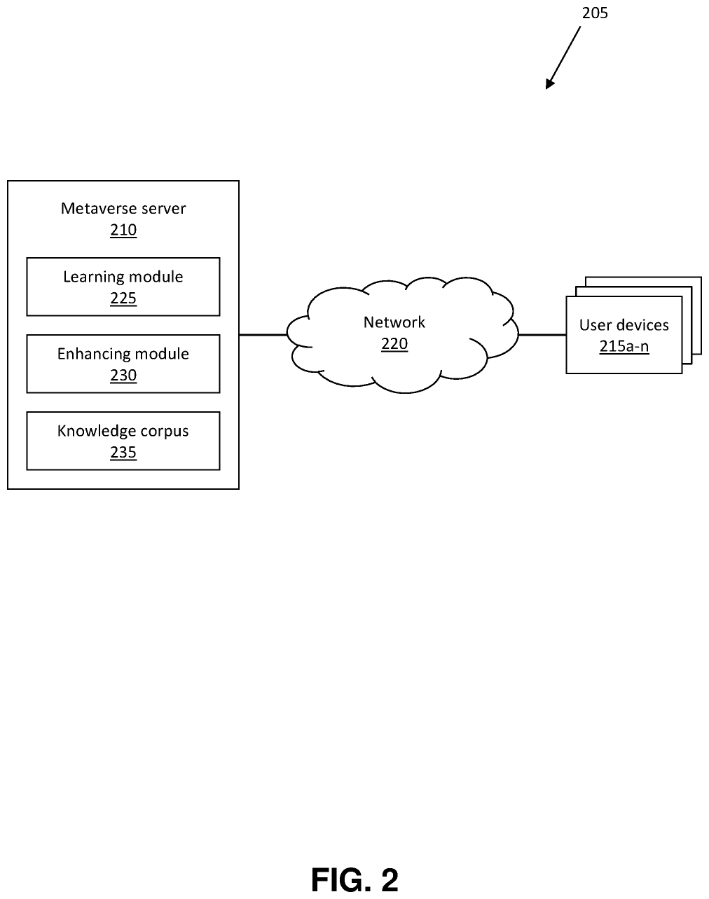

FIG. 2 shows a block diagram of an exemplary environment 205 in accordance with aspects of the invention. In embodiments, the environment 205 includes a metaverse server 210 that communicates with plural user devices 215a-n via a network 220. In one example, the metaverse server 210 comprises one or more instances of the computer 101 of FIG. 1. In one example, the metaverse server 210 comprises one or more virtual machines or containers running on one or more instances of the computer 101 of FIG. 1. In embodiments, the metaverse server 210 is part of a metaverse platform that provides (e.g., generates) a metaverse that users may access via the user devices 215a-n. The user devices 215a-n comprise any number “n” of computing devices, such as end user device 103 of FIG. 1 that run a software client that interfaces with the metaverse platform to provide access to the metaverse. The user devices 215a-n may comprise virtual reality (VR) devices, augmented reality (AR) devices, desktop computers, laptop computers, tablets, smartphones, etc. The network 220 comprises one more networks, such as a LAN, WAN, and the Internet. In one example, the network 220 comprises the WAN 102 of FIG. 1.

In embodiments, the metaverse server 210 of FIG. 2 comprises learning module 225 and enhancing module 230, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The metaverse server 210 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the invention, the learning module 225 is configured to perform a historic learning function that includes analyzing information from historic metaverse collaborative events using artificial intelligence to determine patterns, trends, associations, etc., in the information. In embodiments, the learning module 225 is configured to use the historic learning to identify influencing factors that can enhance the quality of content presentation in a metaverse collaborative event and how the presenter can perform their best in such events. In embodiments, the learning module 225 is configured to use the historic learning to create a knowledge corpus 235 of learned data. In embodiments, the knowledge corpus 235 comprises data stored in persistent storage such as persistent storage 113 or remote database 130 of FIG. 1.

In accordance with aspects of the invention, the enhancing module 230 is configured to use the knowledge corpus 235 to determine one or more of the actions to perform in a metaverse collaborative event in order to enhance the quality of content presentation in the event. In embodiments, the actions comprise one or more of: causing a dummy avatar in the metaverse collaborative event to ask a question to a presenter during the metaverse collaborative event; causing the dummy avatar to display one or more positive influencing factors to audience members in the metaverse collaborative event and the presenter; masking negative influencing factors of one or more of the audience members; inviting one or more of the audience members to the metaverse collaborative event based on determining that the one or more of the audience members are interested in the metaverse collaborative event; and dynamically rearranging the audience members to different locations in three-dimensional space of the metaverse collaborative event.

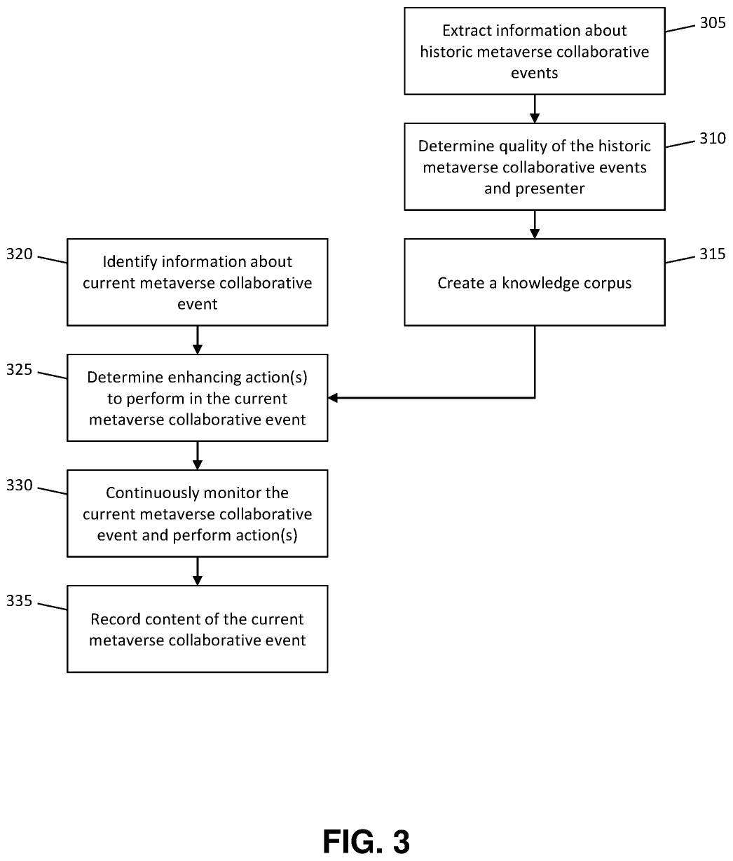

FIG. 3 shows a flowchart of an exemplary method in accordance with aspects of the present invention. Steps of the method may be carried out in the environment of FIG. 2 and are described with reference to elements depicted in FIG. 2. Methods in accordance with FIG. 3 may be used to: perform historic learning to learn how to improve the quality of metaverse collaborative events; and, based on the learning, perform actions in current metaverse collaborative events to enhance (e.g., improve) the quality of the current metaverse collaborative events.

At block 305, the learning module 225 extracts information about historic metaverse collaborative events. The historic metaverse collaborative events may comprise different types of events, such as meetings, performances, lectures, etc. In embodiments, the learning module 225 accesses stored data that defines various aspects of historic metaverse collaborative events, i.e., metaverse collaborative events that have occurred in the past. The stored data may include a recording of the event, a text transcript of the event, metadata about the event (e.g., title, date, topic), meeting minutes, meeting agenda, and user feedback about the event, for example. In embodiments, the module extracts information from the stored data, the information including: measure of effectiveness of a presenter during the event (e.g., determined from presenter feedback/or participant feedback); emotions of the presenter during the event (e.g., determined from presenter feedback); level of interaction between the presenter and the participants (e.g., determined by analyzing text transcript of the event using natural language processing); surrounding context of the metaverse collaborative event (e.g., topic of the event, type of event, etc., determined, e.g., by analyzing one or more or titles, metadata, calendar data, text transcript of the event using natural language processing); and feedback from an audience who viewed recorded content of the metaverse collaborative event (e.g., determined from the feedback). This information may be extracted from recorded sessions of previous metaverse collaborative events using various techniques including but not limited to natural language processing (NLP), which refers to the branch of computer science, and more specifically, the branch of artificial intelligence, concerned with giving computers the ability to understand text and spoken words in much the same way human beings can.

At block 310, the learning module 225 determines a measure of quality for each of the historic metaverse collaborative events from block 305. This may be performed by obtaining and analyzing feedback from participants of the event and users who viewed a recorded session of the event. At block 310, the learning module 225 also determines a level of satisfaction of the presenter with their performance during the event. This may be performed by obtaining and analyzing feedback from the presenter of the event.

At block 315, the learning module 225 creates the knowledge corpus 235 based on the data obtained at block 305 and the determinations made at block 310. In embodiments, the learning module 225 analyzes the data from block 305 and the determinations from block 310 using an artificial intelligence component that is trained to determine: (a) how a presenter can provide their best performance during a metaverse collaborative event, and (b) how the quality of a metaverse collaborative event can be enhanced. For example, the artificial intelligence component may be configured to identify patterns, trends, and/or associations between certain aspects of the data of block 305 and the measures of quality and satisfaction determined at block 310. For example, the artificial intelligence component may be configured to identify which patterns in the data are most often associated with high levels of quality and satisfaction, and conversely which patterns in the data are most often associated with low levels of quality and satisfaction. The patterns in the data that are associated with high levels of satisfaction can be saved in the knowledge corpus 235 as aspects that help a presenter provide their best performance during a metaverse collaborative event. The patterns in the data that are associated with high levels of quality can be saved in the knowledge corpus 235 as aspects that help enhance (e.g., improve) the quality of a metaverse collaborative event.

At block 320, the enhancing module 230 identifies information about a current metaverse collaborative event. In embodiments, the enhancing module 230 identifies the context of the event, a presenter of the event, and participants of the event. The context may include a topic of the event, type of event, etc., and may be determined, e.g., by analyzing one or more or titles, metadata, calendar data, etc. The identities of the presenter and participants may be obtained from metaverse platform, e.g., via user profiles.

At block 325, the enhancing module 230 determines whether one or more actions should be performed to enhance the metaverse collaborative event. In embodiments, the actions includes one or more of: causing a dummy avatar in the metaverse collaborative event to ask a question to a presenter during the metaverse collaborative event; causing the dummy avatar to display one or more positive influencing factors to audience members in the metaverse collaborative event and the presenter; masking negative influencing factors of one or more of the audience members; inviting one or more of the audience members to the metaverse collaborative event based on determining that the one or more of the audience members are interested in the metaverse collaborative event; and dynamically rearranging the audience members to different locations in three-dimensional space of the metaverse collaborative event. In embodiments, the enhancing module 230 determines the actions for the purpose of helping a presenter provide their best performance during a metaverse collaborative event and/or enhancing (e.g., improving) the quality of a metaverse collaborative event. In embodiments, an AI component of the enhancing module 230 determines the actions based on comparing the information about the current metaverse collaborative event from block 320 and the knowledge corpus 235. For example, in response to determining that a pattern of data associated with a high-quality event is absent in the current metaverse collaborative event, the enhancing module 230 may perform an action that is consistent with the missing pattern of data. For example, if the current event has a low level of interaction between the participants and the presenter, and if the knowledge corpus 235 indicates that a high level of interaction is helpful to improve the quality of an event of this type, then the module may add a dummy avatar to the event and cause the dummy avatar to interact with the presenter, e.g., by asking a question related to a topic being presented by the presenter.

At block 330, the enhancing module 230 continues to evaluate the current metaverse collaborative event to determine if actions should be taken to help a presenter provide their best performance during the event and/or enhance the quality of the event. Block 330 may include the enhancing module 230 performing additional actions in the event for the purpose of helping the presenter provide their best performance during the event and/or enhancing the quality of the event.

At block 335, the system records the content of the current metaverse collaborative event. The recorded content can be viewed by other users at a later time. The knowledge corpus 235 can be updated based on the content of the current metaverse collaborative event by performing the steps associated with blocks 305, 310, and 315.

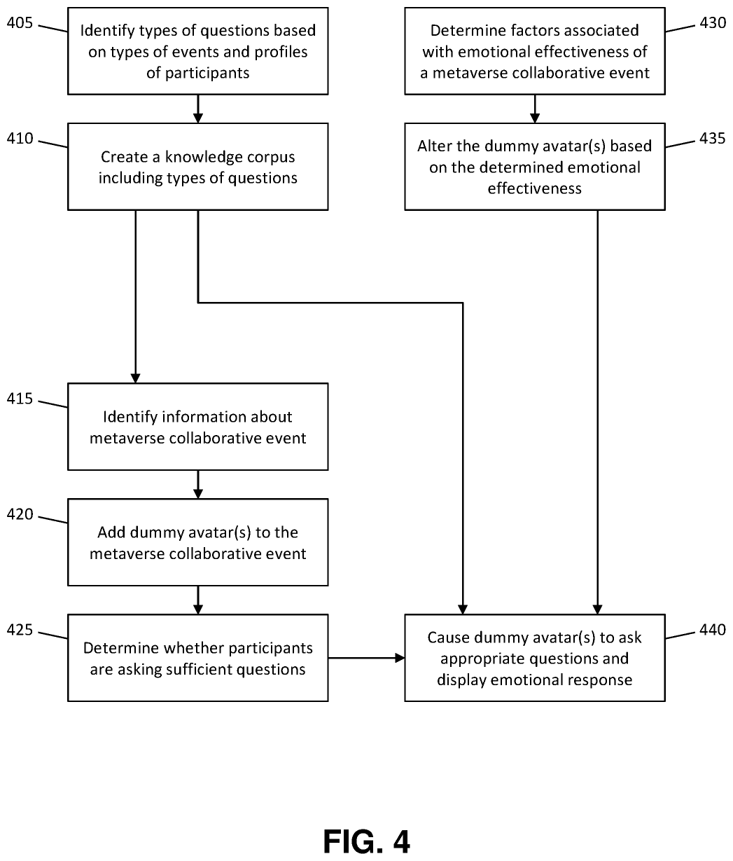

FIG. 4 shows a flowchart of an exemplary method in accordance with aspects of the present invention. Steps of the method may be carried out in the environment of FIG. 2 and are described with reference to elements depicted in FIG. 2. Methods in accordance with FIG. 4 may be used to: control dummy avatars in a metaverse collaborative event to cause the dummy avatar to ask appropriate questions and improve emotional effectiveness of the conversation in the metaverse collaborative event.

At block 405, the learning module 225 identifies types of questions asked at metaverse collaborative events based on types of the events and profiles of participants at the events. In embodiments, the learning module 225 accesses stored data that defines various aspects of historic metaverse collaborative events, i.e., metaverse collaborative events that have occurred in the past. The stored data may include a recording of the event, a text transcript of the event, metadata about the event (e.g., title, date, topic), meeting minutes, meeting agenda, and user feedback about the event, for example. In embodiments, the module identifies information from the stored data, the information including: what types of questions are asked by different participants for different types of events; and profiles of participants and types of questions asked by the participants during the events. The learning module 225 may use NLP techniques to extract this information from the stored data about the historic metaverse collaborative events.

At block 410, the learning module 225 creates a knowledge corpus based on the information from block 405. In embodiments, the knowledge corpus at block 410 is the knowledge corpus 235 of FIG. 2 and may be the same knowledge corpus as that of block 315 of FIG. 3 or may be a different knowledge corpus. In embodiments, the knowledge corpus at block 410 comprises data that defines what types of questions are asked at metaverse collaborative events based on a combination of type of event and profiles of participants at the event. In embodiments, the AI component of the learning module 225 creates a ranking of the questions based on a contextual analysis of importance, knowledge of the participants, etc.

At block 415, the enhancing module 230 identifies information about a current metaverse collaborative event. In embodiments, the enhancing module 230 identifies a context of the event, a presenter of the event, and participants of the event. The context may include a topic or agenda of the event, type of event, etc., and may be determined, e.g., by analyzing one or more or titles, metadata, calendar data, etc. The identities of the presenter and participants may be obtained from metaverse platform, e.g., via user profiles. The profiles may define types of participants, such as role (e.g., teacher, student, engineer, data scientist, musician, etc.), topics of knowledge or experience (e.g., math, science, music, cooking, etc.), and levels of knowledge or expertise (e.g., low, medium, high, etc.) Implementations of the invention are not limited to these types, and other types may be used.

At block 420, the enhancing module 230 adds one or more dummy avatars to the current metaverse collaborative event. In embodiments, the enhancing module 230 adds the dummy avatars based on historical information related to patterns of questions and emotional effectiveness of the conversation happening in the current metaverse collaborative event. In embodiments, the enhancing module 230 adds the dummy avatars by causing the metaverse platform to render a dummy avatar in the three-dimensional space of the current metaverse collaborative event so that the presenter and participants of the current metaverse collaborative event can see the dummy avatar. In accordance with aspects of the invention, the dummy avatar is created and controlled by the metaverse platform and, unlike the avatars of the participants, is not controlled by a real-world human user.

At block 425, the enhancing module 230 determines whether the participants of the current metaverse collaborative event are asking sufficient questions and whether the participants are creating a requisite level of emotional effectiveness in the event. In embodiments, the enhancing module 230 determines, from the knowledge corpus, the highest ranked questions for this type of event with the types of participants at the event. In embodiments, the enhancing module 230 determines whether these highest ranked questions have been asked during this event. If these highest ranked questions have not been asked yet during the current metaverse collaborative event, then at block 440 the enhancing module 230 causes one of the dummy avatars to ask one or more of these highest ranked questions, e.g., to the presenter in the event.

At block 430, the learning module 225 determines factors associated with the emotional effectiveness of a metaverse collaborative event. In embodiments, the learning module 225 identifies factors that can cause a metaverse collaborative event to have a better emotional effectiveness. In embodiments, the learning module 225 also identifies what types of body language of the participants are linked to the emotional effectiveness. Block 430 may be performed in a manner similar to block 310 of FIG. 3, but with the artificial intelligence trained to determine these factors associated with the emotional effectiveness. At block 435, the enhancing module 230 alters the dummy avatar(s) based on the determined emotional effectiveness factors.

At block 440, the enhancing module 230 causes the dummy avatar(s) in the current metaverse collaborative event to ask appropriate questions and/or display an emotional response. In embodiments, the enhancing module 230 causes the dummy avatar(s) to ask appropriate questions in a timely manner and to show an appropriate emotional response. The questions asked by the dummy avatar(s) stimulate conversation in the current metaverse collaborative event, which can be beneficial for the presenter and participants. The emotional response shown by the dummy avatar(s) encourages the presenter.

Methods in accordance with FIG. 4 may be used to evaluate the effectiveness of a metaverse collaboration. In embodiments, the methods may include: analyzing the collaboration content and identifying the participants of the collaborative event; identifying the profile of the participants and what types of questions are being asked by the participants; using a knowledge corpus created using historical learning to determine, for the same profiles and same types of collaboration content, a sufficient number of participants and interactions, whether appropriate questions are being asked, a required ratio of interactive participants to total participants, and required body language (e.g., clapping); and comparing the same with the knowledge corpus to identify whether the same is aligned with the required level of effectiveness.

Methods in accordance with FIG. 4 may be used to artificially create a required level of effectiveness for a metaverse collaboration. In embodiments, the methods may include: causing dummy avatars to ask appropriate questions on behalf of the participants; causing the dummy avatars to take appropriate positions in the collaborative environment; causing the dummy avatars to interact with the participants (e.g., introducing, etc.); and causing the dummy avatars to perform appropriate emotional response to the at the effectiveness of the collaborative event can be improved.

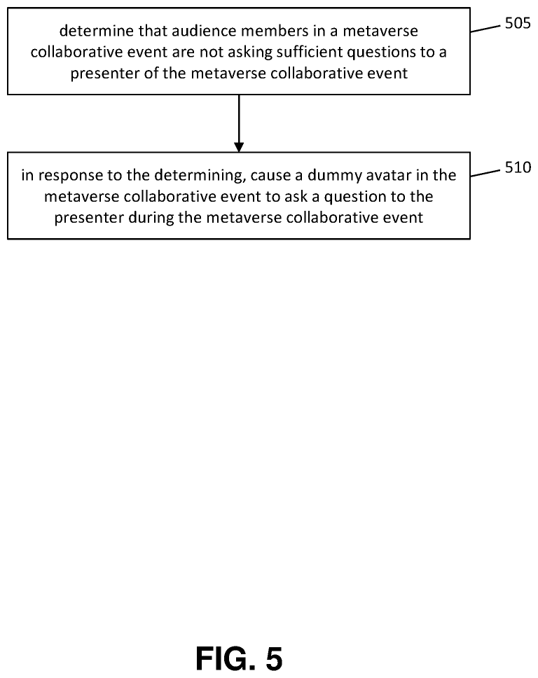

FIG. 5 shows a flowchart of an exemplary method in accordance with aspects of the present invention. Steps of the method may be carried out in the environment of FIG. 2 and are described with reference to elements depicted in FIG. 2.

At step 505, the system determines that participants in a metaverse collaborative event are not asking sufficient questions to a presenter of the metaverse collaborative event. In embodiments, the metaverse collaborative event takes place in a three-dimensional space in a virtual world and the participants and presenter are visible to each other in the three-dimensional space. In embodiments, a sufficiency of questions is based on a predefined criteria. In one example, the predefined criteria comprises questions determined from a knowledge corpus, and the enhancing module 230 determines that the participants in the metaverse collaborative event are not asking sufficient questions based on questions determined from the knowledge corpus 235. In another example, the predefined criteria comprises a lack of understanding, and the enhancing module 230 determines that the participants in the metaverse collaborative event are not asking sufficient questions based on a determined lack of understanding of one of the participants.

At step 510, in response to the determining of step 505, the system causes a dummy avatar in the metaverse collaborative event to ask a question to the presenter during the metaverse collaborative event. In embodiments, the enhancing module 230 causes the metaverse platform to render and new dummy avatar in the metaverse collaborative event, or to control an existing dummy avatar in the metaverse collaborative event, to ask a question to the presenter during the metaverse collaborative event. In one example, the question is based on a knowledge corpus. In another example, the question is based on a determined lack of understanding of one of the participants.

The method of FIG. 5 may further comprise the system causing the dummy avatar to display one or more positive influencing factors to the participants and the presenter. In embodiments, the enhancing module 230 causes the dummy avatar to display an emotional response such as clapping and/or nodding in agreement. In embodiments, the displaying the emotional response is intended to help the presenter provide their best performance during the metaverse collaborative event.

The method of FIG. 5 may further comprise the system masking negative influencing factors of one or more of the participants. In embodiments, the enhancing module 230 determines that one or more of the participants is performing a negative behavior such as laughing while another user (e.g., participant or presenter) is speaking. In embodiments, the enhancing module 230 causes the metaverse platform to adjust the rendering to mask this negative behavior so that it is not visible to the other participants and the presenter in the metaverse collaborative event.

The method of FIG. 5 may further comprise the system inviting one or more of the participants to the metaverse collaborative event based on determining that the one or more of the participants are interested in the metaverse collaborative event. In embodiments, the enhancing module 230 compares information about the metaverse collaborative event to profiles of users in the metaverse that includes the metaverse collaborative event. In one example, the enhancing module 230 determines that a user is interested in the metaverse collaborative event when the comparing identifies a sufficient match (e.g., greater than a predefined threshold matching score) between a topic of interest of a user and a topic of the metaverse collaborative event. In another example, the enhancing module 230 determines that a user is interested in the metaverse collaborative event when the comparing identifies a sufficient match (e.g., greater than a predefined threshold matching score) between the user and the presenter.

The method of FIG. 5 may further comprise the system dynamically rearranging the participants to different locations in the three-dimensional space. In embodiments, the enhancing module 230 determines that the spacing of participants in the three-dimensional space of the metaverse collaborative event is less than a predefined threshold value. This may occur, for example, when the avatars of all the participants are tightly clustered in a small area of the three-dimensional space, such as all sitting in a same corner of a room. In this situation, the enhancing module 230 may be configured to dynamically move one or more of the participant avatars to other locations in the three-dimensional space of the metaverse collaborative event such that the spacing exceeds the predefined threshold value. In embodiments, the locations are spread out throughout the space of the metaverse collaborative event and are visible by the presenter during the metaverse collaborative event. In this manner, the presenter is provided with a view of a more spread-out audience, which can help the present perform better in the event.

In the method of FIG. 5, the determining that the participants in the metaverse collaborative event are not asking sufficient questions may comprise comparing questions asked during the metaverse collaborative event to questions determined from a knowledge corpus. The questions may be determined from a knowledge corpus such as that described at block 410 of FIG. 4.

In the method of FIG. 5, the determining that the participants in the metaverse collaborative event are not asking sufficient questions may comprise determining that one of the participants does not understand a topic presented by the presenter during the metaverse collaborative event. In embodiments, the enhancing module 230 may use behavioral modeling techniques to determine when one of the participants does not understand what the presenter is saying. In response to this, the enhancing module 230 may be configured to cause one of the dummy avatars to ask a question such as, “Will you please elaborate on that?” or “Can you please explain that topic again?”.

The method of FIG. 5 may further include creating the knowledge corpus 235. In embodiments, the learning module 225 creates the knowledge corpus in the manner described at one or both of block 315 of FIG. 3 and block 410 of FIG. 4.

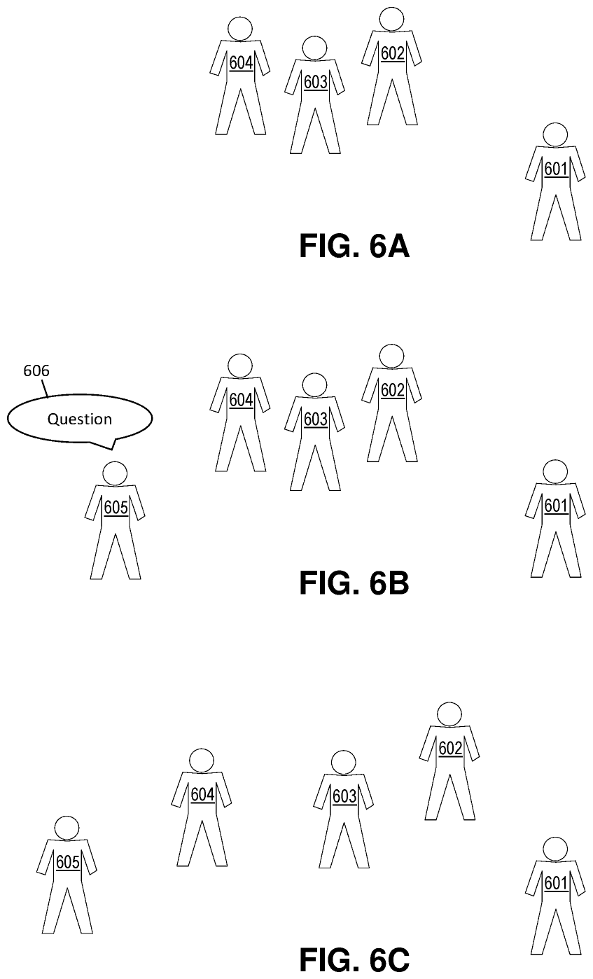

FIGS. 6A, 6B, and 6C illustrate example use cases in accordance with aspects of the present invention. FIG. 6A shows a presenter 601 and participants 602, 603, and 604 in a metaverse collaborative event. Each of the presenter 601 and participants 602-604 are represented by avatars in the metaverse in which the metaverse collaborative event is taking place, and each is controlled by a real-world user via one of user devices 215a-n of FIG. 2.

FIG. 6B shows a dummy avatar 605 added to the metaverse collaborative event of FIG. 6A. In this example, the enhancing module 230 adds the dummy avatar in response to determining that the participants 602-604 are not asking sufficient questions during the metaverse collaborative event. In this example, the dummy avatar 605 asks a question 606 represented generally by the word “Question”. The question 606 may be based on questions determined from a knowledge corpus or may be based on a determined lack of understanding of one of the participants 602-604. In embodiments, the question 606 is visible and/or audible to the presenter 601 and participants 602-604 via normal communication channels in the metaverse.

FIG. 6C shows the dummy avatar 605 and the participants 602-604 spread out to different locations in the space of the metaverse collaborative event. As described herein, the enhancing module 230 may perform such dynamic rearranging based on determining that the spacing of the participants 602-604 is insufficient.

In one or both of FIGS. 6B and 6C, the enhancing module 230 may cause the dummy avatar 605 to display a positive influencing factor such as clapping or nodding in agreement. This can provide encouragement to the presenter 601 and thus enhance the experience for the presenter.

In one or both of FIGS. 6B and 6C, the enhancing module 230 may mask a negative influencing factor of one of the participants 602-604, such as laughing at a comment made by the presenter or another one of the participants. This can mask negative emotional displays that may be detrimental to the performance of the presenter 601 during the event.

Various aspects of the present disclosure are illustrated in the following description of operations. Embodiments may employ some or all of the following operations in different combinations. For example, the methods of FIGS. 3, 4, and 5 may employ some or all of the following operations. Aspects of the operations may be carried out in the environment of FIG. 2 and are described with reference to elements depicted in FIG. 2.

In an operation, the metaverse server 210 gathers different historic metaverse collaborations and associated content. This may include, for example, creation of study material, presentation contents, etc. In embodiments, the historic metaverse collaborations were recorded and stored. In these operations, a metaverse collaboration is synonymous with a metaverse collaborative event.

In another operation, the metaverse server 210 performs image analysis of recorded metaverse content and the associated dynamic information in the metaverse collaborative content.

In another operation, the metaverse server 210 gathers feedback from the presenter of a historic metaverse collaboration and identifies how well the presenter performed in the collaboration.

In another operation, the metaverse server 210 obtains biometric parameters of the presenter captured during the historic metaverse collaboration to identify how well the presenter performed during the collaboration. The presenter can also provide manual feedback indicating how well they think they performed.

In another operation, the metaverse server 210 receives feedback from an audience of the historic metaverse collaboration. The audience may comprise participants who attended the event or other users who watch the recording of the collaboration. This feedback may indicate an audience member's opinion of how well the presenter performed during the event and the level of quality of the collaboration.

In another operation, the metaverse server 210 extracts information from historic metaverse collaborations, the information including: distribution of the audience; level of interaction; cheering-up of the audience from the metaverse environment; metaverse collaborative surrounding; topic of the metaverse content; and profiles of the audience and presenter.

In another operation, the metaverse server 210 performs a historic learning function based on the aforementioned information. In embodiments, based on the historic learning, the metaverse server 210 creates a knowledge corpus that identifies correlations between aspects of the aforementioned information and: (i) how a presenter can perform their best during a metaverse collaboration; and (ii) how the quality of a metaverse collaboration can be enhanced.

In another operation, after the knowledge corpus is created, the metaverse server 210 dynamically creates an appropriate environment during a metaverse collaboration so that the quality of metaverse collaboration content can be improved.

In another operation, when a metaverse collaborative environment is to be created, the metaverse server 210 gathers the detail about the metaverse collaboration.

In another operation, the metaverse server 210 identifies the current audience (e.g., participants) that are present in the metaverse collaborative environment.

In another operation, the metaverse server 210 predicts what types of audience members might appreciate the current metaverse collaboration. In another operation, the metaverse server 210 identifies which audience members can improve the performance of the presenter.

In another operation, the metaverse server 210 invites the identified audience members to join in the metaverse collaborative environment.

In another operation, the metaverse server 210 continues to identify which users have joined in the metaverse collaboration, and continues to predict users that can help improve the performance of the presenter in the metaverse collaboration.

In another operation, the metaverse server 210 appropriately distributes those users in the environment of the metaverse collaboration.

In another operation, the metaverse server 210 determines the users that can create a positive impact on the presenter and places these uses in the environment of the metaverse collaboration so that the presenter can view them clearly during metaverse collaboration.

In another operation, during the metaverse collaboration, the metaverse server 210 identifies whether an increased level of interaction with the audience would increase the effectiveness of the presenter or the overall quality of the metaverse collaboration.

In another operation, the metaverse server 210 tracks whether the audience (of real-world users) in the metaverse collaboration is interacting with the presenter.

In another operation, the metaverse server 210 places a virtual dummy avatar audience apart from an actual audience avatar in the environment of the metaverse collaboration.

In another operation, the metaverse server 210 causes the virtual dummy avatars to perform appropriate interactions with the presenter so that the presenter can continue to be motivated and high-quality content can be created.

In another operation, the metaverse server 210 continues to evaluate real-time emotion of the presenter during the metaverse collaboration and performs actions to maintain alignment with the best possible performance.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
determining, by a processor set, that participants in a metaverse collaborative event are not asking sufficient questions to a presenter of the metaverse collaborative event, wherein the metaverse collaborative event takes place in a three-dimensional space in a virtual world and the participants and presenter are visible to each other in the three-dimensional space, and wherein a sufficiency of questions is based on a predefined criteria; and
in response to the determining, causing, by the processor set, a dummy avatar in the metaverse collaborative event to ask a question to the presenter during the metaverse collaborative event.

2. The computer-implemented method of claim 1, further comprising causing the dummy avatar to display one or more positive influencing factors to the participants and the presenter.

3. The computer-implemented method of claim 1, further comprising masking negative influencing factors of one or more of the participants.

4. The computer-implemented method of claim 1, further comprising inviting one or more of the participants to the metaverse collaborative event based on determining that the one or more of the participants are interested in the metaverse collaborative event.

5. The computer-implemented method of claim 1, further comprising dynamically rearranging the participants to different locations in the three-dimensional space.

6. The computer-implemented method of claim 1, wherein the determining that the participants in the metaverse collaborative event are not asking sufficient questions comprises comparing questions asked during the metaverse collaborative event to questions determined from a knowledge corpus.

7. The computer-implemented method of claim 6, further comprising creating the knowledge corpus based on analyzing plural different historic metaverse collaborative events.

8. The computer-implemented method of claim 1, wherein the determining that the participants in the metaverse collaborative event are not asking sufficient questions comprises determining that one of the participants does not understand a topic presented by the presenter during the metaverse collaborative event.

9. A computer program product comprising one or more computer readable storage media having program instructions collectively stored on the one or more computer readable storage media, the program instructions executable to:
determine that participants in a metaverse collaborative event are not asking sufficient questions to a presenter of the metaverse collaborative event, wherein the metaverse collaborative event takes place in a three-dimensional space in a virtual world and the participants and presenter are visible to each other in the three-dimensional space, and wherein a sufficiency of questions is based on a predefined criteria; and
in response to the determining, cause a dummy avatar in the metaverse collaborative event to ask a question to the presenter during the metaverse collaborative event.

10. The computer program product of claim 9, wherein program instructions are executable to cause the dummy avatar to display one or more positive influencing factors to the participants and the presenter.

11. The computer program product of claim 9, wherein program instructions are executable to mask negative influencing factors of one or more of the participants.

12. The computer program product of claim 9, wherein program instructions are executable to invite one or more of the participants to the metaverse collaborative event based on determining that the one or more of the participants are interested in the metaverse collaborative event.

13. The computer program product of claim 9, wherein program instructions are executable to dynamically rearrange the participants to different locations in the three-dimensional space.

14. The computer program product of claim 9, wherein the determining that the participants in the metaverse collaborative event are not asking sufficient questions comprises one of: comparing questions asked during the metaverse collaborative event to questions determined from a knowledge corpus; and determining that one of the participants does not understand a topic presented by the presenter during the metaverse collaborative event.

15. A system comprising:
a processor set, one or more computer readable storage media, and program instructions collectively stored on the one or more computer readable storage media, the program instructions executable to:
determine that participants in a metaverse collaborative event are not asking sufficient questions to a presenter of the metaverse collaborative event, wherein the metaverse collaborative event takes place in a three-dimensional space in a virtual world and the participants and presenter are visible to each other in the three-dimensional space, and wherein a sufficiency of questions is based on a predefined criteria; and
in response to the determining, cause a dummy avatar in the metaverse collaborative event to ask a question to the presenter during the metaverse collaborative event.

16. The system of claim 15, wherein program instructions are executable to cause the dummy avatar to display one or more positive influencing factors to the participants and the presenter.

17. The system of claim 15, wherein program instructions are executable to mask negative influencing factors of one or more of the participants.

18. The system of claim 15, wherein program instructions are executable to invite one or more of the participants to the metaverse collaborative event based on determining that the one or more of the participants are interested in the metaverse collaborative event.

19. The system of claim 15, wherein program instructions are executable to dynamically rearrange the participants to different locations in the three-dimensional space.

20. The system of claim 15, wherein the determining that the participants in the metaverse collaborative event are not asking sufficient questions comprises one of: comparing questions asked during the metaverse collaborative event to questions determined from a knowledge corpus; and determining that one of the participants does not understand a topic presented by the presenter during the metaverse collaborative event.
